(19) United States
(12) Patent Application Publication
(10) Pub. No.: US 2016/0185964 A1
(43) Pub. Date: Jun. 30, 2016

(54) POLYIMIDE PRECURSOR COMPOSITION, POLYIMIDE MOLDED ARTICLE, AND METHOD FOR PREPARING POLYIMIDE MOLDED ARTICLE

(71) Applicant: FUJI XEROX CO., LTD., Tokyo (JP)

(72) Inventors: Kana MIYAZAKI, Kanagawa (JP); Tsuyoshi MIYAMOTO, Kanagawa (JP)

(21) Appl. No.: 14/718,532

(22) Filed: May 21, 2015

(30) Foreign Application Priority Data
Dec. 25, 2014 (JP) 2014-263068

(51) Int. Cl. C08L 79/08

(52) U.S. Cl. CPC C08L 79/08

(57) ABSTRACT

A polyimide precursor composition includes a resin having repeating units represented by the following formula (I), a lactone compound, an organic amine compound, and a solvent including water, wherein the resin, the lactone compound and the organic amine compound are dissolved in the solvent:

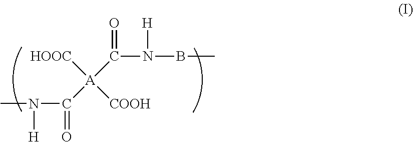

wherein A represents a tetravalent organic group and B represents a divalent organic group.

### CROSS-REFERENCE TO RELATED APPLICATIONS

This application is based on and claims priority under 35 USC 119 from Japanese Patent Application No. 2014-263068 filed Dec. 25, 2014.

### BACKGROUND

1. Technical Field

The present invention relates to a polyimide precursor composition, a polyimide molded article, and a method for preparing a polyimide molded article.

2. Related Art

A polyimide resin is a material having characteristics of high durability and excellent heat resistance, and has been widely used in electronic material applications.

### SUMMARY

According to an aspect of the invention, there is provided a polyimide precursor composition including a resin having repeating units represented by the following formula (I), a lactone compound, an organic amine compound, and a solvent including water,

wherein the resin, the lactone compound and the organic amine compound are dissolved in the solvent:

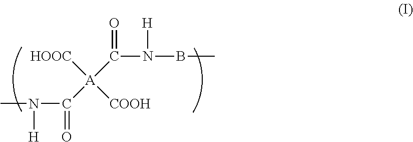

wherein A represents a tetravalent organic group and B represents a divalent organic group.

### DETAILED DESCRIPTION

Hereinafter, the exemplary embodiments of the invention will be described in detail.

Polyimide Precursor Composition

The polyimide precursor composition according to the present exemplary embodiment is a composition in which a resin having repeating units represented by the formula (I) (hereinafter referred to as a “specific polyimide precursor”), a lactone compound, and an organic amine compound are dissolved in a solvent including water (hereinafter referred to as an “aqueous solvent” for convenience). That is, the specific polyimide precursor, the lactone compound, and the organic amine compound are included in an aqueous solvent in the dissolved state. Further, the dissolution means a state in which no residues can be visually observed.

The polyimide precursor composition according to the present exemplary embodiment has excellent storage stability (hereinafter also referred to as a “pot life”). The reason for this is not clear, but is presumably due to the reasons shown below.

First, in the polyimide precursor composition according to the present exemplary embodiment, when an organic amine compound is dissolved in an aqueous solvent, a specific polyimide precursor (a carboxyl group thereof) is formed into an amine salt with the organic amine compound. Therefore the solubility of the specific polyimide precursor in an aqueous solvent may be improved, and thus, the polyimide precursor composition including an organic amine compound has good film forming properties and is suitable as a composition for forming a polyimide molded article.

Here, in the polyimide precursor composition, when both of an organic amine compound and a lactone compound are dissolved in a single solvent of an organic solvent, an acid catalyst is formed from the organic amine compound and the lactone compound to promote imidization on heating during the molding of a molded article, and thus, the molding at a low temperature is easily accomplished.

However, the acid catalyst, which is formed from the organic amine compound and the lactone compound, is produced even at room temperature (for example, 25° C.) in some cases. When this acid catalyst is produced, the imidization reaction is promoted even in a room temperature environment (for example, 25° C.) in some cases. Further, when the imidization reaction is promoted, viscosity variation or precipitation of resins occurs, and thus, the storage stability of the polyimide precursor composition is reduced in some cases.

In contrast, when both of an organic amine compound and a lactone compound are dissolved in an aqueous solvent including water, the organic amine compound easily contributes to chlorination of the specific polyimide precursor (a carboxyl group thereof) even at room temperature, and thus, an acid catalyst is hardly produced from the organic amine compound and the lactone compound. Thus, the imidization reaction is hardly promoted by the catalytic action of the acid catalyst, and thus, viscosity variation and precipitation of resins are prevented.

Accordingly, it is predicted that the polyimide precursor composition according to the present exemplary embodiment has excellent storage stability. In addition, the acid catalyst is produced from the organic amine compound and the lactone compound on heating during the molding of a molded article, and thus, imidization is promoted. As a result, the molding at a low temperature is easily accomplished.

Furthermore, a polyimide molded article obtained by molding the polyimide precursor composition according to the present exemplary embodiment has enhanced surface smoothness. Further, various characteristics such as mechanical characteristics, heat resistance, electrical characteristics, and solvent resistance are also improved. In addition, since the polyimide precursor composition has superior storage stability, the coating performance (coating stability) of the polyimide precursor composition is easily maintained at a high level, and variations in the qualities of the polyimide molded article are prevented.

Here, when the organic amine compound is included in the polyimide precursor composition, the organic amine compound easily volatilizes on heating during molding, and as a result, voids are easily formed on the surface of the polyimide molded article. Therefore, the appearance qualities (that is, surface smoothness) of the molded article are deteriorated in some cases. In contrast, in the polyimide precursor composition according to the present exemplary embodiment, an imidization reaction is promoted by an acid catalyst formed from the organic amine compound and the lactone during heating, and thus, baking at a low temperature is easily accomplished. For this reason, the organic amine compound hardly volatilizes. Therefore, formation of voids on the surface of the polyimide molded article is prevented, whereby the surface smoothness is easily improved.

In the polyimide precursor composition according to the present exemplary embodiment, since the specific polyimide precursor and the organic amine compound are dissolved in the aqueous solvent, corrosion of a substrate as a base material is prevented during molding of the polyimide molded article. This is considered to be due to a fact that the acidity of a carboxyl group of the specific polyimide precursor is prevented by the basicity of the coexistent organic amine compound.

In the polyimide precursor composition according to the present exemplary embodiment, in a case where a specific polyimide precursor (for example, a synthesized resin formed of an aromatic tetracarboxylic dianhydride and an aromatic diamine compound), in which in the formula (I), A represents a tetravalent aromatic organic group and B represents a divalent aromatic organic group, is applied, the specific polyimide precursor usually tends to be hardly dissolved in a solvent. However, since an aqueous solvent is applied as the solvent and an organic amine compound is incorporated therein, the specific polyimide precursor is dissolved in the solvent in the chlorinated state due to the organic amine compound. For this reason, even in a case where an aromatic polyimide precursor is applied as the specific polyimide precursor, the film forming properties are superior and the environmental suitability is excellent.

In the polyimide precursor composition according to the present exemplary embodiment, an aqueous solvent including water as the solvent is applied. For this reason, the polyimide precursor composition according to the present exemplary embodiment has excellent environmental suitability. Further, when a polyimide molded article is molded using the polyimide precursor composition according to the present exemplary embodiment, a lower heating temperature for evaporation of a solvent and a shorter heating time are accomplished.

In the polyimide precursor composition according to the present exemplary embodiment, the specific polyimide precursor as a polyimide precursor is not a low-molecular weight compound, does not have a structure in which the solubility thereof in a solvent is increased by introducing a flexible chain, an aliphatic cyclic structure, or the like into the primary structure to reduce the force of interaction between polymer chains, and is dissolved in the solvent by applying an aqueous solvent as the solvent and incorporating an amine compound thereto, whereby the specific polyimide precursor (a carboxyl group thereof) is formed into an amine salt with the organic amine compound. For this reason, a decrease in the mechanical strength of the polyimide molded article dose not occur, which is caused when the molecular weight of the polyimide precursor is decreased or the molecular structure is changed for improving solubility of a polyimide precursor resin as seen in the method in the related art, and further, the dissolution of the polyimide precursor in water is facilitated.

Hereinafter, the respective components of the polyimide precursor composition according to the present exemplary embodiment will be described.

Specific Polyimide Precursor

The specific polyimide precursor is a resin (polyamic acid) having repeating units represented by the formula (I). Further, the imidization rate of the specific polyimide precursor is preferably 0.2 or less.

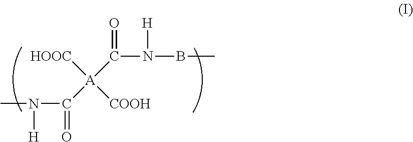

In the formula (I), A represents a tetravalent organic group and B represents a divalent organic group.

Here, in the formula (I), the tetravalent organic group represented by A is a residue formed by removing four carboxyl groups from a tetracarboxylic dianhydride as a raw material.

On the other hand, the divalent organic group represented by B is a residue formed by removing two amino groups from a diamine compound as a raw material.

That is, the specific polyimide precursor having repeating units represented by the formula (I) is a polymer formed from a tetracarboxylic dianhydride and a diamine compound.

The tetracarboxylic dianhydride may be any one of an aromatic compound and an aliphatic compound, with the aromatic compound being preferable. That is, the tetravalent organic group represented by A in the formula (I) is preferably an aromatic organic group.

Examples of the aromatic tetracarboxylic dianhydride include pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenylethertetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-biphenyltetracarboxylic dianhydride, 2,3,3′,4′-biphenyltetracarboxylic dianhydride, bis(phthalic acid)phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenylether dianhydride, and bis(triphenylphthalic acid)-4,4′-diphenylmethane dianhydride.

Examples of the aliphatic tetracarboxylic dianhydride include aliphatic or alicyclic tetracarboxylic dianhydrides such as butanetetracarboxylic dianhydride, 1,2,3,4-cyclobutanetetracarboxylic dianhydride, 1, 3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetrahydrofuryl)-3-methyl-3-cyclohexene-1,2-di carboxylic dianhydride, and bicyclo[2,2,2]-oct-7-ene-2,3,5,6-tetracarboxylic dianhydride; and aliphatic tetracarboxylic dianhydrides having an aromatic ring, such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Among those, as the tetracarboxylic dianhydride, aromatic tetracarboxylic dianhydrides are preferable, and specifically, for example, pyromellitic dianhydride, 3,3′,4,4′-biphenyltetracarboxylic dianhydride, 2,3,3′,4′-biphenyltetracarboxylic dianhydride, 3,3′,4,4′-biphenylethertetracarboxylic dianhydride, and 3,3′,4,4′-benzophenonetetracarboxylic dianhydride are preferable, and pyromellitic dianhydride, 3,3′,4,4′-biphenyltetracarboxylic dianhydride, and 3,3′,4,4′-benzophenonetetracarboxylic dianhydride are more preferable, and 3,3′,4,4′-biphenyltetracarboxylic dianhydride is particularly preferable.

Moreover, the tetracarboxylic dianhydrides may be used alone or in combination of two or more kinds thereof.

Further, in a case where two or more kinds thereof are used in combination, a combination of two or more kinds of the aromatic tetracarboxylic dianhydrides, a combination of two or more kinds of the aliphatic tetracarboxylic acids, or a combination of at least one aromatic tetracarboxylic dianhydride and at least one aliphatic tetracarboxylic dianhydride may be used.

On the other hand, the diamine compound is a diamine compound having two amino groups in the molecular structure. Examples of the diamine compound include any aromatic or aliphatic diamine compounds, but the aromatic compounds are preferable. That is, the divalent organic group represented by B in the formula (I) is preferably an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenylether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bonded to an aromatic ring and hetero atoms other than nitrogen atoms of the amino groups such as diaminotetraphenyl thiophene; and aliphatic and alicyclic diamines such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylene dimethylenediamine, tricyclo[6,2,1,0^{2.7}]-undecylene dimethyldiamine, and 4,4′-methylenebis(cyclohexylamine).

Among those, as the diamine compound, aromatic diamine compounds are preferable, and specifically, for example, p-phenylenediamine, m-phenylenediamine, 4,4′-diaminodiphenylmethane, 4,4′-diaminodiphenylether, 3,4′-diaminodiphenylether, 4,4′-diaminodiphenylsulfide, and 4,4′-diaminodiphenylsulfone are preferable, and 4,4′-diaminodiphenylether and p-phenylenediamine are particularly preferable.

Moreover, the diamine compounds may be used alone or in combination of two or more kinds thereof. Further, in a case where two or more kinds thereof are used in combination, a combination of two or more kinds of the aromatic diamine compounds, a combination of two or more kinds of the aliphatic diamine compounds, or a combination of at least one aromatic diamine compound and at least one aliphatic diamine compound may be used.

The specific polyimide precursor is preferably a resin having an imidization rate of 0.2 or less. That is, the specific polyimide precursor may be a partially imidized resin.

Specifically, examples of the specific polyimide precursor include resins having repeating units represented by the formulae (I-1), (I-2), and (I-3).

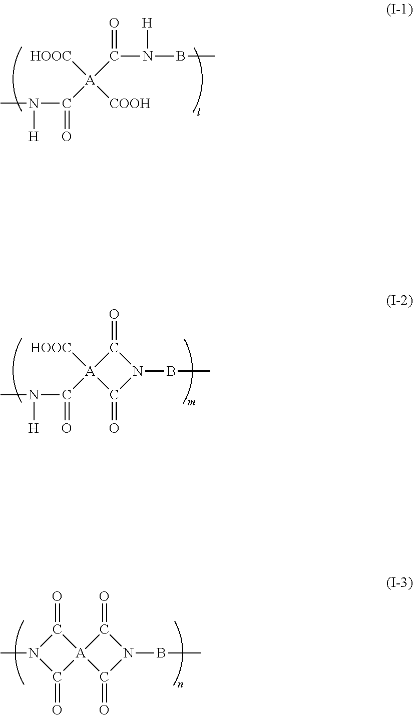

In the formulae (I-1), (I-2), and (I-3), A represents a tetravalent organic group and B represents a divalent organic group. Further, A and B have the same definitions as A and B in the formula (I).

l represents an integer of 1 or more, and m and n each independently represent 0 or an integer of 1 or more, with l, m, and n satisfying a relationship of (2n+m)/(2l+2m+2n)≦0.2.

In the formulae (I-1) to (I-3), l represents an integer of 1 or more, preferably an integer of 1 to 200, and more preferably an integer of 1 to 100. m and n each independently represent 0 or an integer of 1 or more, preferably each independently represent 0 or an integer of 1 to 200, and more preferably 0 or an integer of 1 to 100.

Furthermore, 1, m, and n satisfy a relationship of (2n+m)/(2l+2m+2n)≦0.2, preferably satisfy a relationship of (2n+m)/(2l+2m+2n)≦0.15, and more preferably satisfy a relationship of (2n+m)/(2l+2m+2n)≦0.10.

Here, “(2n+m)/(2l+2m+2n)” represents a ratio of the number (2n+m) of coupling parts having an imide ring closure to the total number (2l+2m+2n) of coupling parts with respect to the coupling parts (reaction parts of the tetracarboxylic dianhydride with the diamine compound) of the specific polyimide precursor. That is, “(2n+m)/(2 l+2m+2n)” represents the imidization rate of the specific polyimide precursor.

In addition, the specific polyimide precursor may be prevented from causing gelation or separation with precipitation by setting the imidization rate of the specific polyimide precursor (value of “(2n+m)/(2l+2m+2n)”) to 0.2 or less (preferably 0.15 or less, and more preferably 0.10 or less).

The imidization rate of the specific polyimide precursor (value of “(2n+m)/(2l+2m+2n)”) is measured by the following method.

Measurement of Imidization Rate of Polyimide Precursor

Preparation of Polyimide Precursor Sample

(i) The polyimide precursor composition to be measured is coated onto a silicone wafer in a film thickness falling within the range of 1 μm to 10 μm to prepare a coating film sample.

(ii) The coating film sample is dipped in tetrahydrofuran (THF) for 20 minutes to replace the solvent in the coating film sample with tetrahydrofuran (THF). The solvent for dipping is not limited to THF and may be selected from solvents that do not dissolve the polyimide precursor and may be miscible with a solvent component contained in the polyimide precursor composition. Specifically, an alcohol solvent such as methanol and ethanol and an ether compound such as dioxane may be used.

(iii) The coating film sample is taken out of the THF, and N₂ gas is blown onto the surface of the coating film sample to remove the THF. The coating film sample is dried by treating the coating film sample for 12 hours or longer in the range of 5° C. to 25° C. under a pressure reduced to 10 mmHg or less, thereby preparing a polyimide precursor sample.

Preparation of 100% Imidized Standard Sample

(iv) The polyimide precursor composition to be measured is coated onto a silicone wafer in the same manner as in the section (i) above to prepare a coating film sample.

(v) The coating film sample is heated for 60 minutes at 380° C. to perform an imidization reaction, thereby preparing a 100% imidized standard sample.

Measurement and Analysis (Measurement Examples and Analysis Examples of Polyimide Precursor Samples Including 4,4′-Diaminodiphenylether and 3,3′,4,4′-Biphenyltetracarboxylic Dianhydride)

(vi) By using a Fourier transform infrared spectrophotometer (FT-730 manufactured by HORIBA, Ltd.), the infrared absorption spectra of the 100% imidized standard sample and the polyimide precursor sample are measured. The 100% imidized standard sample is measured to obtain a ratio 1′ (100) of an absorption peak (Ab′ (1780 cm⁻¹)) derived from an imide bond around 1780 cm⁻¹ to an absorption peak (Ab′ (1500 cm⁻¹)) derived from an aromatic ring around 1500 cm⁻¹.

(vii) Likewise, the polyimide precursor sample is measured to determine a ratio I (x) of an absorption peak (Ab (1780 cm⁻¹)) derived from an imide bond around 1780 cm⁻¹ to an absorption peak (Ab (1500 cm⁻¹)) derived from an aromatic ring around 1500 cm⁻¹.

In addition, by using the respective absorption peaks I′ (100) and I (x) thus measured, an imidization rate of the polyimide precursor is calculated based on the following formula.

Imidization rate of polyimide precursor=I(x)/I′(100) Formula

I′(100)=(Ab′(1780 cm⁻¹))/(Ab′(1500 cm⁻¹)) Formula

I(x)=(Ab(1780 cm⁻¹))/(Ab(1500 cm⁻¹)) Formula

Moreover, this measurement of an imidization rate of the polyimide precursor is applied to the measurement of an imidization rate of an aromatic polyimide precursor. For measuring the imidization rate of an aliphatic polyimide precursor, instead of the absorption peak of an aromatic ring, a peak derived from a structure that does not change before and after the imidization reaction is used as an internal standard peak.

Ratio of Tetracarboxylic Dianhydrides to Diamine Compounds

In the specific polyimide precursor, the molar equivalents of the diamine compound are preferably larger than the molar equivalents of the tetracarboxylic dianhydride. When this relationship is satisfied, the film forming properties of the polyimide precursor composition are easily enhanced. In addition, the mechanical strength of the polyimide molded article is also easily increased.

This relationship is accomplished by adjusting the molar equivalents of the diamine compound used in the polymerization reaction to be in excess of the molar equivalents of the tetracarboxylic dianhydride. Regarding the ratio of the molar equivalents of the tetracarboxylic dianhydride to the molar equivalents of the diamine compound, the molar equivalents of the diamine compound with respect to one molar equivalent of the tetracarboxylic dianhydride are preferably in the range of 1.0001 to 1.2000, and more preferably in the range of 1.0010 to 1.2000.

When the ratio of the molar equivalents of the diamine compound to the molar equivalents of the tetracarboxylic dianhydride is 1.0001 or more, the effect of the amino group at a terminal of the molecule is increased, the dispersion properties of the specific polyimide precursor are increased, and thus the film forming property of the polyimide precursor composition is easily improved. Further, the mechanical strength of the polyimide molded article is easily enhanced. In addition, dispersion of various fillers added in order to provide the polyimide molded article with various functions is promoted, and thus, superior functions are easily exhibited even with a small amount of a filler. On the other hand, when the ratio of the molar equivalents is 1.2000 or less, the molecular weight of the polyimide precursor is easily increased, and thus, for example, when forming the polyimide molded article in the shape of a film, the film strength (break strength and tensile strength) is easily increased.

Here, in the specific polyimide precursor, the ratio of the molar equivalents of the diamine compound to the molar equivalents of the tetracarboxylic dianhydride is measured in the following manner. The specific polyimide precursor resin is subjected to a hydrolysis treatment in a basic aqueous solution of sodium hydroxide, potassium hydroxide, or the like to thereby be decomposed into a diamine compound and a tetracarboxylate. The obtained sample is analyzed by gas chromatography, liquid chromatography, or the like, and the proportions of the tetracarboxylic dianhydride and the diamine compound constituting the specific polyimide precursor are determined.

Terminal Structure of Polyimide Precursor

The specific polyimide precursor preferably includes a polyimide precursor (resin) having an amino group at a terminal thereof, and preferably is a polyimide precursor having amino groups on all terminals thereof.

When the polyimide precursor (resin) having a terminal amino group is included, the effect of the amino group at a terminal of the molecule is improved, the dispersion properties of the specific polyimide precursor is increased, and thus, the film forming properties of the polyimide precursor composition are easily improved. Further, the mechanical strength of the polyimide molded article is easily increased. Further, the dispersion of various fillers added so as to impart various functions to the polyimide molded article is promoted, and thus, superior functions are easily expressed even with a small amount of the filler.

Some or all of the terminal amino groups of the polyimide precursor having a terminal amino group may be sealed with a dicarboxylic anhydride or the like. When the terminal amino groups are sealed, the storage stability of the polyimide precursor composition is easily increased.

Examples of the dicarboxylic anhydride used to seal the terminal amino group include phthalic anhydride and fumaric anhydride.

The terminal amino group of the specific polyimide precursor is detected by allowing trifluoroacetic anhydride to undergo a reaction with a polyimide precursor composition (quantitative reaction with amino groups). That is, the terminal amino group of the specific polyimide precursor is amidated with trifluoroacetic acid. After the treatment, the specific polyimide precursor is purified by reprecipitation or the like to remove excessive trifluoroacetic anhydride or residues of trifluoroacetic acid. The specific polyimide precursor after the treatment is quantified by means of a nuclear magnetic resonance (NMR) method to measure the amount of the terminal amino groups of the specific polyimide precursor.

Number Average Molecular Weight of Polyimide Precursor

The number average molecular weight of the specific polyimide precursor is preferably from 1000 to 100000, more preferably from 5000 to 50000, and still more preferably from 10000 to 30000.

When the number average molecular weight of the specific polyimide precursor is within the above range, the decrease in the solubility of the specific polyimide precursor in a solvent is prevented, and thus, the film forming properties are easily secured. In particular, in a case where a specific polyimide precursor including a resin having a terminal amino group is applied, a lower molecular weight leads to a higher ratio of the terminal amino groups present, and is easily affected by the coexistent organic amine compound in the polyimide precursor composition, thereby decreasing the solubility. However, by setting the number average molecular weight of the specific polyimide precursor to be within the above range, the decrease in the solubility may be prevented.

In addition, a specific polyimide precursor having a desired number average molecular weight is obtained by adjusting the ratio of the molar equivalents of the tetracarboxylic dianhydride to the molar equivalents of the diamine compound.

The number average molecular weight of the specific polyimide precursor is measured by gel permeation chromatography (GPC) under the following measurement conditions.

Column: TSKgel α-M (7.8 mm I.D.×30 cm) manufactured by Tosoh Corporation

Eluent: dimethylformamide (DMF)/30 mM LiBr/60 mM phosphoric acid

Flow rate: 0.6 mL/min

Injection amount: 60 μL

Detector: RI (Differential refractive index detector)

The content (concentration) of the specific polyimide precursor is preferably from 0.1% by weight to 40% by weight, more preferably from 0.5% by weight to 25% by weight, and still more preferably from 1% by weight to 20% by weight, based on the entire polyimide precursor composition.

Organic Amine Compound

The organic amine compound is a compound which not only converts a specific polyimide precursor (a carboxyl group thereof) to an amine salt to thereby increase its solubility in the solvent, but also functions as an imidization promoter. The organic amine compound is a non-surface active amine compound having no surface activity. Specifically, the organic amine compound is preferably an amine compound having a molecular weight of 170 or less. In addition, the organic amine compound is preferably a compound excluding a diamine compound which is a raw material for a polyimide precursor.

Further, the organic amine compound is preferably a water-soluble compound. Here, the term “water-soluble” means that target compounds are dissolved at 1% by weight or more with respect to water at 25° C.

Examples of the organic amine compound include a primary amine compound, a secondary amine compound, and a tertiary amine compound.

Among these, at least one selected from a secondary amine compound and a tertiary amine compound (in particular, a tertiary amine compound) is preferable as the organic amine compound. When the tertiary amine compound or the secondary amine compound (particularly, the tertiary amine compound) is applied as the organic amine compound, the solubility of the specific polyimide precursor in a solvent is easily increased, the film forming properties are easily improved, and further, the storage stability of the polyimide precursor composition is easily improved.

Furthermore, examples of the organic amine compound include, in addition to the monovalent amine compound, a divalent or higher polyvalent amine compound. When the divalent or higher polyvalent amine compound is applied, a pseudo-cross-linked structure between the molecules of the specific polyimide precursor is easily formed, and further, the storage stability of the polyimide precursor composition is easily improved.

Examples of the primary amine compound include methylamine, ethylamine, n-propylamine, isopropylamine, 2-ethanolamine, and 2-amino-2-methyl-1-propanol.

Examples of the secondary amine compound include dimethylamine, 2-(methylamino)ethanol, 2-(ethylamino)ethanol, and morpholine.

Examples of the tertiary amine compound include 2-dimethylaminoethanol, 2-diethylaminoethanol, 2-dimethylaminopropanol, triethylamine, picoline, methylmorpholine, and ethylmorpholine.

Here, as the organic amine compound, an amine compound having a nitrogen-containing heterocyclic structure (particularly, the tertiary amine compound) is also preferable from the viewpoint of the film forming properties. Examples of the amine compound having a nitrogen-containing heterocyclic structure (hereinafter referred to as a “nitrogen-containing heterocyclic amine compound”) include isoquinolines (amine compounds having isoquinoline skeletons), pyridines (amine compounds having pyridine skeletons), pyrimidines (amine compounds having pyrimidine skeletons), pyrazines (amine compounds having pyrazine skeletons), piperazines (amine compounds having piperazine skeletons), triazines (amine compounds having triazine skeletons), imidazoles (amine compounds having imidazole skeletons), polyaniline, polypyridine, and polyamine.

From the viewpoint of the film forming properties, as the nitrogen-containing heterocyclic amine compound, at least one selected from the group consisting of morpholines, pyridines, and imidazoles is preferable, and at least one selected from the group consisting of N-methylmorpholine, pyridine, and picoline is more preferable.

Among those, as the organic amine compound, a compound having a boiling point of 60° C. or higher (preferably from 60° C. to 200° C., and more preferably from 70° C. to 150° C.) is preferable. When the boiling point of the organic amine compound is set to 60° C. or higher, the organic amine compound is prevented from volatilizing from the polyimide precursor composition during storage, and reduction in the solubility of the specific polyimide precursor in a solvent is easily prevented.

The content of the organic amine compound is preferably from 50% by mole to 200% by mole (preferably from 50% by mole to 150% by mole, and more preferably from 100% by mole to 120% by mole) with respect to the carboxyl groups (—COOH) of the polyimide precursor in the polyimide precursor composition. When the content of the organic amine compound is set to 50% by mole or more, the polyimide precursor is easily dissolved in the aqueous solvent. When the content of the organic amine compound is set to 200% by mole or less, sufficient stability of the organic amine compound in the solution is easily obtained and further, unfavorable odor is easily prevented.

The organic amine compounds may be used alone or in combination of two or more kinds thereof.

Lactone Compound

The lactone compound is a compound which forms an acid catalyst by an equilibrium reaction with an organic amine compound during heating and baking, and thus functions as an imidization promoter. Specifically, the lactone compound is a lactone compound having a molecular weight of 150 or less.

Further, the lactone is preferably a water-soluble compound. Here, the term “water-soluble” means that a target compound is dissolved at 1% by weight or more with respect to water at 25° C.

The lactone compound is a compound including a cyclic ester structure (specifically, a cyclic ester structure containing an “—O—C(═O)— group”: hereinafter referred to as a “lactone ring”) containing an ether group (—O—) and a carbonyl group (C═O).

Examples of the lactone compound include lactone compounds having a 3- to 8-membered ring (preferably a 5- to 7-membered ring).

Examples of the lactone compound include an unsubstituted lactone and a substituted lactone. Examples of the substituted lactone include substituted lactones substituted with at least one selected from an alkyl group (for example, a linear, branched, or cyclic alkyl group having 1 to 10 carbon atoms), an alkoxy group (for example, a linear or branched alkoxy group having 1 to 10 carbon atoms), an acyl group (for example, a linear or branched acyl group having 1 to 10 carbon atoms), an aryl group (for example, a phenyl group), and an aralkyl group (for example, a benzyl group).

Specific examples of the lactone compound include γ-valerolactone, β-valerolactone, γ-caprolactone, γ-heptalactone, α-acetyl-γ-butyrolactone, and ε-caprolactone, but are not limited thereto.

Among these, as the lactone compound, at least one selected from the group consisting of γ-valerolactone, β-valerolactone, and ε-caprolactone is preferable.

The content of the lactone compound is preferably from 0.01% by weight to 500% by weight, more preferably from 0.1% by weight to 200% by weight, and still more preferably from 1% by weight to 100% by weight, with respect to the weight of the specific polyimide precursor, from the viewpoint of storage stability.

The content of the lactone compound is preferably from 0.01% by mole to 100% by mole, more preferably from 0.1% by mole to 90% by mole, and still preferably from 1% by mole to 80% by mole, with respect to the organic amine compound, from the viewpoint of storage stability.

Aqueous Solvent

The aqueous solvent is a solvent including water. Specifically, the aqueous solvent is preferably a solvent including water in an amount of 10% by weight or more with respect to the entire aqueous solvent. Here, the term “water-soluble” means that a target compound is dissolved at 1% by weight or more with respect to water at 25° C.

Examples of water include distilled water, ion-exchanged water, ultra-filtered water, and pure water.

The content of water is preferably from 50% by weight to 100% by weight, more preferably from 70% by weight to 100% by weight, still more preferably from 80% by weight to 100% by weight, and particularly preferably from 90% by weight to 100% by weight, with respect to the total aqueous solvent. Further, the aqueous solvent most preferably does not include a solvent other than water.

In a case where the aqueous solvent includes a solvent other than water, examples of the solvent other than water include a water-soluble organic solvent and an aprotic polar solvent. As the solvent other than water, a water-soluble organic solvent is preferable from the viewpoints of the transparency, the mechanical strength, and the like of the polyimide molded article. Particularly, from the viewpoints of enhancing various characteristics such as heat resistance, electrical characteristics, and solvent resistance, in addition to the transparency and the mechanical strength, of the polyimide molded article, the aqueous solvent preferably does not include an aprotic polar solvent or include, if any, a small amount of an aprotic polar solvent (for example, 10% by weight or less with respect to the total of the water-soluble solvent).

Examples of the water-soluble organic solvent include a water-soluble ether solvent, a water-soluble ketone solvent, and a water-soluble alcohol solvent.

The water-soluble organic solvents may be used alone, but in a case where they are used in combination of two or more kinds thereof, examples of the combination include a combination of a water-soluble ether solvent and a water-soluble alcohol solvent, a combination of a water-soluble ketone solvent and a water-soluble alcohol solvent, and a combination of a water-soluble ether solvent, a water-soluble ketone solvent, and a water-soluble alcohol solvent.

The water-soluble ether solvent is a water-soluble solvent having an ether bond in one molecule. Examples of the water-soluble ether solvent include tetrahydrofuran (THF), dioxane, trioxane, 1,2-dimethoxyethane, diethylene glycol dimethyl ether, and diethylene glycol diethyl ether. Among these, tetrahydrofuran and dioxane are preferable as the water-soluble ether solvent.

The water-soluble ketone solvent is a water-soluble solvent having a ketone group in one molecule. Examples of the water-soluble ketone solvent include acetone, methyl ethyl ketone, and cyclohexanone. Among these, acetone is preferable as the water-soluble ketone solvent.

The water-soluble alcohol solvent is a water-soluble solvent having an alcoholic hydroxyl group in one molecule. Examples of the water-soluble alcohol solvent include methanol, ethanol, 1-propanol, 2-propanol, tert-butyl alcohol, ethylene glycol, a monoalkyl ether of ethylene glycol, propylene glycol, a monoalkyl ether of propylene glycol, diethylene glycol, a monoalkyl ether of diethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerin, 2-ethyl-2-hydroxymethyl-1,3-propanediol, and 1, 2, 6-hexanetriol. Among these, as the water-soluble alcohol solvent, methanol, ethanol, 2-propanol, ethylene glycol, a monoalkyl ether of ethylene glycol, propylene glycol, a monoalkyl ether of propylene glycol, diethylene glycol, and a monoalkyl ether of diethylene glycol are preferable.

The aprotic polar solvent refers to a solvent having a boiling point of 150° C. to 300° C. and a dipole moment of 3.0 D to 5.0 D. Specific examples of the aprotic polar solvent include N-methyl-2-pyrrolidone (NMP), N,N-dimethylformamide (DMF), N,N-dimethylacetamide (DMAc), dimethylsulfoxide (DMSO), hexamethylenephosphoramide (HMPA), N-methylcaprolactam, and N-acetyl-2-pyrrolidone.

Incidentally, in a case where a solvent other than water is contained as the aqueous solvent, the solvent used in combination has a boiling point of preferably 250° C. or lower, more preferably 60° C. to 200° C., and still more preferably from 80° C. to 150° C. If the boiling point of the solvent used in combination is within the above range, the solvent other than water does not easily remain in a polyimide molded article, and a polyimide molded article having high mechanical strength is easily obtained.

Other Additives

The polyimide precursor composition according to the present exemplary embodiment may contain various fillers and the like for the purpose of imparting various functions such as conductivity and mechanical strength to the polyimide molded article that is prepared using the composition. The polyimide precursor composition may also contain a catalyst for promoting an imidization reaction, a leveling material for improving the quality of a film formed, and the like.

Examples of the conductive material added for imparting conductivity include a conductive material (having a volume resistivity of, for example, less than 10⁷ Ω·cm, which shall apply hereinafter) and a semi-conductive material (having a volume resistivity of, for example, 10⁷ Ω·cm to 10¹³ Ω·cm, which shall apply hereinafter), and the material is selected according to the purpose of use.

Examples of conductive materials include carbon black (for example, acidic carbon black having a pH of 5.0 or less), metals (for example, aluminum and nickel), metal oxides (for example, yttrium oxide and tin oxide), ionic conductive substances (for example, potassium titanate and LiCl), and conductive polymers (for example, polyaniline, polypyrrole, polysulfone, and polyacetylene).

These conductive materials may be used alone or in combination of two or more kinds thereof.

In addition, in a case where the conductive material has a particle form, particles having a primary particle diameter of less than 10 μm, and preferably 1 μm or less are preferable.

Examples of the filler added for enhancing the mechanical strength include materials in the form of particles, such as silica powder, alumina powder, barium sulfate powder, titanium oxide powder, mica, and talc. In addition, in order to improve water repellency or releasability of the surface of a polyimide molded article, fluorine resin powder such as polytetrafluoroethylene (PTFE) and a tetrafluoroethylene-perfluoroalkyl vinyl ether copolymer (PFA), and the like may be added.

As the catalyst for promoting the imidization reaction, a dehydrating agent such as an anhydride; an acid catalyst such as a phenol derivative, a sulfonic acid derivative, and a benzoic acid derivative; or the like may also be used.

The content of other additives may be selected according to the purpose of use of the polyimide molded article to be prepared.

Method for Preparing Polyimide Precursor Composition

A method for preparing a polyimide precursor composition according to the present exemplary embodiment is not particularly limited, but examples thereof include a preparation method, in which a tetracarboxylic dianhydride and a diamine compound are polymerized in the presence of an organic amine compound and a lactone compound in an aqueous solvent including water to produce a resin (specific polyimide precursor).

Further, the preparation method as shown herein may include a step of substituting the solvent or changing the composition of the solvent after the polymerization step, as necessary.

Polyimide Molded Article and Method for Preparing the Same

A method for preparing the polyimide molded article according to the present exemplary embodiment is a method for preparing a polyimide molded article, in which the polyimide precursor composition according to the present exemplary embodiment (hereinafter also referred to as a “specific polyimide precursor composition”) is subjected to a heating treatment for molding.

Specifically, the method for preparing the polyimide molded article according to the present exemplary embodiment includes, for example, a step in which a specific polyimide precursor composition is coated onto an object to be coated, thereby forming a coating film (hereinafter referred to as a “coating film forming step”), and a step in which the coating film is subjected to a heating treatment, thereby forming a polyimide resin layer (hereinafter referred to as a “heating step”).

Coating Film Forming Step

First, an object to be coated is prepared. This object to be coated is selected according to the applications of a polyimide molded article to be prepared.

Specifically, in a case where a liquid crystal alignment film is prepared as a polyimide molded article, examples of the object to be coated include various substrates applied in liquid crystal elements, and examples thereof include a silicon substrate, a glass substrate, or substrates having a metal or alloy film formed on the surface of these substrates.

Furthermore, in a case where a passivation film is prepared as a polyimide molded article, the object to be coated is selected from, for example, a semiconductor substrate having an integrated circuit formed thereon, a wiring substrate having wires formed thereon, a printed substrate having electronic parts and a wiring board provided thereon, and the like.

In addition, in a case where an electrical wire coating material is prepared as a polyimide molded article, examples of the object to be coated include various electrical wires (wires, bars, or plates of metals or alloys such as soft copper, hard copper, oxygen-free copper, chromium ore, and aluminum). Further, in a case where the polyimide molded article is molded and processed into a tape form, and used as a coating material for electrical wires in the form of a tape that is wound onto the electrical wire, various planar substrates or cylindrical substrates are used as the object to be coated.

In addition, in a case where an adhesive film is prepared as a polyimide molded article, examples thereof include various molded articles which are objects to be adhered (for example, various electrical parts such as a semiconductor chip and a printed substrate).

Next, the specific polyimide precursor composition is coated onto a desired object to be coated to form a coating film of the specific polyimide precursor composition.

The method for coating the specific polyimide precursor composition is not particularly limited, and examples thereof include various coating methods such as a spray coating method, a spin coating method, a roll coating method, a bar coating method, a slit die coating method, and an ink jet coating method.

Heating Step

Next, the coating film of the specific polyimide precursor composition is subjected to a drying treatment. By this drying treatment, a dried film (dried film before imidization) is formed.

For the heating conditions for the drying treatment, the heating temperature is, for example, preferably from 80° C. to 200° C., the heating time is preferably from 10 minutes to 60 minutes, and when the temperature is higher, the heating time may be shorter. During the heating, hot air blowing is also effective. During the heating, the temperature may be raised stepwise or raised without changing the rate.

Next, the dried film is subjected to an imidization treatment. Thus, a polyimide resin layer is formed.

For the heating conditions for the imidization treatment, the imidization reaction occurs, for example, by heating at 150° C. to 400° C. (preferably 200° C. to 300° C.) for 20 minutes to 60 minutes, thereby forming a polyimide resin layer. During the heating reaction, heating is preferably carried out by raising the temperature stepwise or slowly at a constant rate before reaching the final temperature of heating.

Through the steps above, a polyimide molded article is formed. Further, if desired, a polyimide molded article is extracted from the object to be coated and subjected to post-processing.

Polyimide Molded Article

The polyimide molded article according to the present exemplary embodiment is a polyimide molded article obtained by the method for preparing the polyimide molded article according to the present exemplary embodiment. Examples of this polyimide molded article include various polyimide molded articles such as a liquid crystal alignment film, a passivation film, an electrical wire coating material, and an adhesive film. Other examples of the polyimide molded article include a flexible electronic-substrate film, a copper-clad laminated film, a laminate film, an electrical insulation film, a porous film for a fuel cell, a separation film, a heat-resistant film, an IC package, a resist film, a flattened film, a microlens-array film, and an optical-fiber-coating film.

Other examples of the polyimide molded article include a belt member. Examples of the belt member include a driving belt, a belt for an electrophotographic image forming apparatus (for example, an intermediate transfer belt, a transfer belt, a fixing belt, and a transport belt).

That is, the method for preparing the polyimide molded article according to the present exemplary embodiment may be applied to methods for preparing various polyimide molded articles as exemplified above.

The polyimide molded article according to the present exemplary embodiment includes the aqueous solvent, an organic amine compound, and a lactone compound included in the specific polyimide precursor composition.

The amount of the aqueous solvent contained in the polyimide molded article according to the present exemplary embodiment is 1 ppb or more and less than 1% in the polyimide molded article. The amount of the aqueous solvent contained in the polyimide molded article is determined by means of gas chromatography on the gas fraction generated by heating the polyimide molded article. In addition, the amounts of the organic amine compound and the lactone compound included in the polyimide molded article are also determined by means of gas chromatography on the gas fraction generated by heating the polyimide molded article.

### EXAMPLES

Examples will be described below, but the invention is not limited to these Examples. Further, in the description below, both of “parts” and “%” are based on weight unless specified otherwise.

### Example 1

### Preparation of Polyimide Precursor Composition (A-1)

Polymerization Step

900 g of water as an aqueous solvent is filled into a flask equipped with a stirring rod, a thermometer, and a dropping funnel. 10.00 g (99.88 mmoles) of γ-valerolactone as a lactone compound, 27.28 g (252.27 mmoles) of p-phenylenediamine (hereinafter denoted as PDA: molecular weight of 108.14) as a diamine compound, and 50.00 g (494.32 mmoles) of methylmorpholine (hereinafter denoted as MMO: organic amine compound) as an organic amine compound are added thereto, and the mixture is dispersed by stirring at 20° C. for 10 minutes. Further, to this solution is added 72.72 g (247.16 mmoles) of 3,3′,4,4′-biphenyltetracarboxylic dianhydride (hereinafter denoted as BPDA: molecular weight of 294.22) as a tetracarboxylic dianhydride, and the mixture is dissolved by stirring for 24 hours while maintaining the reaction temperature at 20° C. to carry out a reaction, thereby obtaining a polyimide precursor composition (A-1).

Furthermore, the storage stability is evaluated, and then a film is prepared by using the composition and evaluated in terms of coating stability and film forming properties. The evaluation results are shown in Table 1.

Here, for the polyimide precursor composition (A-1) immediately after the preparation thereof, the solid content, the liquid state, the imidization rate, and the molecular weight (number average molecular weight Mn) of the polyimide precursor, and the solid content as a polyimide (the solid content of the polyimide), the viscosity, and the presence or absence of a terminal amino group in the polyimide precursor are investigated.

In addition, the imidization rate of the produced polyimide precursor is 0.02, and as a result of measuring the amount of terminal amino groups as described above, it is found that the polyimide precursor contains an amino group at least at a terminal thereof.

Various measurement methods (measurement methods other than the aforementioned methods) are as below.

Method for Measuring Viscosity

The viscosity is measured using an E-type viscometer under the following conditions.
Measurement instrument: E-type rotating viscometer TV-20H (TORI SANGYO Co., Ltd.)
Measurement probe: No. 3-type rotor 3°×R14
Measurement temperature: 22° C.

Method for Measuring Solid Content

The solid content is measured using a thermo gravimetry/differential thermal Analyzer under the following conditions. Further, the value measured at 380° C. is used and the solid content is measured as a proportion of the solid content as polyimide.
Measurement instrument: Thermo Gravimetry/Differential Thermal Analyzer TG/DTA 6200 (Seiko Instruments Inc.)
Measurement range: 20° C. to 400° C.
Rate of increasing temperature: 20° C./min

Evaluation

The storage stability of the obtained polyimide precursor composition (A-1) is evaluated. Further, the polyimide precursor composition (A-1) is used to prepare a film, and the film is evaluated in terms of the coating stability and the film forming properties.

Storage Stability

The liquid state, the viscosity, and the imidization rate of the polyimide precursor composition (A-1) are investigated immediately after preparation of the polyimide precursor composition (A-1) and after it is stored at room temperature (25° C.) for 20 days.

Coating Stability

Coating is carried out using the polyimide precursor composition (A-1) by the following operation. The coating film immediately after the coating is evaluated in terms of (1) surface unevenness and patterns and (2) cissing.
Coating method: a bar coating method using a coating blade equipped with a spacer to yield a coating thickness of 100 μm
Coating substrate: glass plate having a thickness of 1.1 mm

(1) Surface Unevenness and Patterns

The presence or absence of surface unevenness and patterns on the surface of the coating film is evaluated. The evaluation criteria are as follows.

A: Surface unevenness and patterns are not found.

B: It is possible to confirm surface unevenness and patterns to a slight extent in a portion of the surface of the coating film (less than 10% of the surface area of the coating film).

C: It is possible to confirm surface unevenness and patterns in a portion of the surface of the coating film.

D: Surface unevenness and patterns are evenly caused on the surface of the coating film (10% or more of the surface area of the coating film).

(2) Cissing

The presence or absence of cissing on the surface of the coating film is evaluated. The evaluation criteria are as follows.

A: Cissing is not found.

B: It is possible to confirm cissing to a slight extent in a portion of the surface of the coating film (less than 5% of the surface area of the coating film).

C: It is possible to confirm cissing in a portion of the surface of the coating film.

D: Cissing is evenly caused on the surface of the coating film (15% or more of the surface area of the coating film).

Film Forming Properties

The polyimide precursor composition (A-1) is used to prepare a film by the following procedure. The prepared film is evaluated in terms of (3) void marks, (4) surface unevenness and patterns, and (5) whitening.

Coating method: a bar coating method using a coating blade equipped with a spacer to yield a coating thickness of 100 μm
Coating substrate: glass plate having a thickness of 1.1 mm
Drying temperature: 60° C. for 10 minutes
Baking temperature: 250° C. for 30 minutes

(3) Void Marks

The presence or absence of void marks on the surface of the prepared film is evaluated. The evaluation criteria are as follows.

A: Void marks are not found.

B: It is possible to confirm 1 or more and less than 10 void marks on the surface of the prepared film.

C: There are 10 or more and less than 50 void marks scattered on the surface of the prepared film.

D: Numerous void marks are evenly caused on the surface of the prepared film.

(4) Surface Unevenness and Patterns

The presence or absence of surface unevenness and patterns on the surface of the prepared film is evaluated. The evaluation criteria are as follows.

A: Surface unevenness and patterns are not found.

B: It is possible to confirm surface unevenness and patterns to a slight extent in a portion of the surface of the prepared film (less than 10% of the surface area of the prepared film).

C: It is possible to confirm surface unevenness and patterns in a portion of the surface of the prepared film.

D: Surface unevenness and patterns are evenly caused on the surface of the prepared film (10% or more of the surface area of the prepared film).

(5) Whitening:

The presence or absence of whitening on the surface of the prepared film is evaluated. The evaluation criteria are as follows.

A: Whitening is not found.

B: It is possible to confirm whitening to a slight extent in a portion of the surface of the prepared film (less than 10% of the surface area of the prepared film).

C: It is possible to confirm whitening in a portion of the surface of the prepared film.

D: Whitening is evenly caused on the surface of the prepared film (10% or more of the surface area of the prepared film).

Tensile Strength and Elongation

From the prepared film, a piece of sample is molded by punching by using a No. 3 dumbbell. The piece of sample is installed in a tensile tester, and under the following conditions, an applied load (tensile strength) at which the sample undergoes tensile breaking and elongation at break (tensile elongation) are measured.
Measurement instrument: Tensile tester 1605 model manufactured by Aikoh Engineering Co., Ltd.
Sample length: 30 mm
Sample width: 5 mm
Tensile rate: 10 mm/min

### Examples 2 to 22

### Preparation of Polyimide Precursor Compositions (A-2) to (A-22)

Polyimide precursor compositions (A-2) to (A-22) are prepared in the same manner as in Example 1, except that the conditions of the polymerization step of the polyimide precursor composition are changed to the conditions described in the following Tables 1 to 5.

Moreover, the storage stability is evaluated in the same manner as in Example 1, and then a film is prepared by using each composition and evaluated in terms of the coating stability and the film forming properties. The evaluation results are shown in Tables 1 to 5.

Here, for the polyimide precursor composition (A-2) to (A-22) immediately after the preparation thereof, the solid content and the like of the polyimide are investigated in the same manner as the polyimide precursor composition (A-1) of Example 1.

Further, as a result of the measurement of the amount of the aforementioned terminal amino groups, the polyimide precursor produced in Example 13 is one having no terminal amino group and having carboxyl groups on all the terminals.

### Comparative Example 1

### Preparation of Polyimide Precursor Compositions (X-1) and (X-2)

900 g of N-methyl-2-pyrrolidone (hereinafter denoted as NMP) as a solvent is filled into a flask equipped with a stirring rod, a thermometer, and a dropping funnel. While purging dry nitrogen gas, 27.28 g (252.27 mmoles) of PDA as a diamine compound, 10.00 g (99.88 mmoles) of γ-valerolactone as a lactone compound, and 72.72 g (247.16 mmoles) of BPDA as a tetracarboxylic dianhydride are added thereto. The mixture is stirred while maintaining the solution temperature at 30° C., and 39.10 g (494.32 mmoles) of pyridine is added thereto. After confirming the dissolution of the diamine compound and the tetracarboxylic dianhydride, the mixture is reacted for 24 hours while maintaining the reaction temperature at 30° C. The viscosity of the polyimide precursor solution (a solid content of the polyimide precursor of 13% by weight) is measured by the method as described above and found to be 120 Pa's. The obtained solution is taken as a polyimide precursor composition (X-1).

Furthermore, the storage stability is evaluated in the same manner as in Example 1, and then a film is prepared by using the composition and is evaluated in terms of the coating stability and the film forming properties. The evaluation results are shown in Table 3.

Here, for the polyimide precursor composition (X-1) immediately after the preparation thereof, the solid content and the like of the polyimide are investigated in the same manner as for the polyimide precursor composition (A-1) of Example 1.

Further, the obtained polyimide precursor composition (X-1) and (A-1) obtained in Example 1 are each stored in an environment of 50° C. for 24 hours. (X-1) after storage is taken as (X-2). The liquid states of (X-2) and (A-1) are compared, and it is found that for (A-1), the resin is dissolved in a substantially uniform state, and thus is stable, but for (X-2), the resin is precipitated. Even in (X-1) immediately after the preparation, the imidization proceeds at an imidization rate of 0.3, but it is presumed that when the storage temperature is set to 50° C., the imidization further proceeds, and thus, the resin is precipitated.

### Comparative Example 2

### Preparation of Polyimide Precursor Composition (X-3)

A polyimide precursor composition (X-3) is prepared in the same manner as for the polyimide precursor composition (A-1) of Example 1, except that the solvent is changed to 900 g of anisole and the organic amine compound is changed to 50.00 g (494.32 mmoles) of MMO. The liquid state of (X-3) after storage at room temperature (25° C.) for 20 days is checked and found to be thickened. The reason therefor is thought to be due to a fact that anisole is used as the solvent and thus, the imidization proceeds slowly.

### Comparative Example 3

Preparation of Polyimide Precursor Composition (X-4)

A polyimide precursor composition (X-4) is prepared in the same manner as for the polyimide precursor composition (A-3) of Example 3, except that γ-valerolactone is not added and the organic amine compound is changed to 37.37 g (472.42 mmoles) of pyridine.

Furthermore, the storage stability is evaluated in the same manner as in Example 1, and then a film is prepared by using the composition and evaluated in terms of coating stability and film forming properties. The evaluation results are shown in Table 3.

Here, for the polyimide precursor composition (X-4) immediately after the preparation thereof, the solid content and the like of the polyimide are investigated in the same manner as for the polyimide precursor composition (A-1) of Example 1.

In addition, for the solution state of (X-4) after storage at room temperature (25° C.) for 20 days, particularly, thickening, precipitation, and the like cannot be seen, but voids are formed in the molded article. Further, deterioration of the dynamic characteristics, which is thought to be due to voids, can be seen. The reason therefor is thought to be a fact that since γ-valerolactone is not added, the proceeding of the imidization is slow, as compared with Example 1 and the temperature capable of baking is increased.

### Comparative Example 4

### Preparation of Polyimide Precursor Composition (X-5)

A polyimide precursor composition (X-5) is prepared in the same manner as for the polyimide precursor composition (A-4) of Example 4, except that MMO is not added. The liquid state of (X-5) after storage at room temperature (25° C.) for 20 days is checked and found to be gelled. The reason therefor is thought to be due to a fact that since MMO is not used, the solubility of the polyimide precursor is reduced.

TABLE 1

| | | | Example/Comparative Example | | | | |
|---|---|---|---|---|---|---|---|
| | | | Example 1 | Example 2 | Example 3 | Example 4 | Example 5 |
| Polyimide precursor composition | | | A-1 | A-2 | A-3 | A-4 | A-5 |
| Synthesis | Tetracarboxylic | Chemical | BPDA | BPDA | PMDA | BTDA | BPDA |
| condition | dianhydride | species | | | | | |
| | | g | 72.72 | 58.9 | 51.52 | 74.32 | 72.72 |
| | | mmol | 247.16 | 200.24 | 236.21 | 223.7 | 247.16 |
| | Diamine | Chemical | PDA | ODA | ODA | PDA | PDA |
| | compound | species | | | | | |
| | | g | 27.28 | 40.9 | 48.24 | 25.45 | 27.28 |
| | | mmol | 252.27 | 204.27 | 240.92 | 235.35 | 252.27 |
| | Tetracarboxylic dianhydride to | | 0.98 | 0.98 | 0.98 | 0.98 | 0.98 |
| | diamine compound (molar ratio) | | | | | | |
| | Organic amine | Chemical | MMO | MMO | MMO | MMO | MMO |
| | compound | species 1 | | | | | |
| | | g | 50.00 | 40.51 | 47.79 | 47.61 | 25.00 |
| | | mmol | 494.32 | 400.48 | 472.42 | 447.4 | 247.16 |
| | | Chemical | — | — | — | — | — |
| | | species 2 | | | | | |
| | | g | — | — | — | — | — |
| | | mmol | — | — | — | — | — |
| | Treatment rate | % by mole | 100 | 100 | 100 | 100 | 30 |
| | Solvent | Chemical | Water | Water | Water | Water | Water |
| | | species 1 | | | | | |
| | | g | 900 | 900 | 900 | 900 | 900 |
| | | Chemical | — | — | — | — | — |
| | | species 2 | | | | | |
| | | g | — | — | — | — | — |
| | Lactone | Chemical | γ-Valero- | γ-Valero- | γ-Valero- | γ-Valero- | γ-Valero- |
| | | species | lactone | lactone | lactone | lactone | lactone |
| | | g | 10.00 | 10.00 | 10.00 | 10.00 | 10.00 |
| | | mmol | 99.88 | 99.88 | 99.88 | 99.88 | 99.88 |
| | Polyimide precursor | % | 13 | 13 | 13 | 13 | 13 |
| | solid content | | | | | | |
| | Liquid state | | Dissolved | Dissolved | Dissolved | Dissolved | Dissolved |
| | Imidization rate | | 0.02 | 0.02 | 0.02 | 0.02 | 0.02 |
| | Molecular weight | Mn | 20000 | 20000 | 20000 | 20000 | 20000 |
| | Polyimide solid | % | 9.1 | 9.1 | 9.3 | 9.2 | 9.1 |
| | content | | | | | | |
| | Viscosity | Pa · s | 60 | 40 | 40 | 30 | 100 |
| | Terminal amino group | | Contained | Contained | Contained | Contained | Contained |
| Storage | Storage condition | | At room | At room | At room | At room | At room |
| stability | | | temperature | temperature | temperature | temperature | temperature |
| | | | for 20 days | for 20 days | for 20 days | for 20 days | for 20 days |
| | Liquid state | | Dissolved | Dissolved | Dissolved | Dissolved | Dissolved |
| | Viscosity | Pa · s | 62 | 65 | 68 | 73 | 70 |
| | Imidization rate | | 0.03 | 0.03 | 0.04 | 0.03 | 0.05 |
| Coating | Surface unevenness and | | A | A | A | B | B |
| stability | patterns | | | | | | |
| | Cissing | | A | A | A | B | B |
| Film | Void marks | | A | A | A | B | B |
| forming | Surface unevenness and | | A | A | A | B | B |
| properties | patterns | | | | | | |
| | Whitening | | A | A | A | B | B |
| Dynamic | Tensile strength | MPa | 320 | 210 | 190 | 320 | 320 |
| character- | Tensile elongation | % | 50 | 90 | 80 | 50 | 50 |
| istics | | | | | | | |

TABLE 2

| | | | Example/Comparative Example | | | | |
|---|---|---|---|---|---|---|---|
| | | | Example 6 | Example 7 | Example 8 | Example 9 | Example 10 |
| Polyimide precursor composition | | | A-6 | A-7 | A-8 | A-9 | A-10 |
| Synthesis | Tetracarboxylic | Chemical | BPDA | BPDA | BPDA | PMDA | BPDA |
| condition | dianhydride | species | | | | | |
| | | g | 72.72 | 72.72 | 72.72 | 51.52 | 72.72 |
| | | mmol | 247.16 | 247.16 | 247.16 | 236.21 | 247.16 |
| | Diamine compound | Chemical | PDA | PDA | PDA | ODA | PDA |
| | | species | | | | | |
| | | g | 27.28 | 27.28 | 27.28 | 48.24 | 27.28 |
| | | mmol | 252.27 | 252.27 | 252.27 | 240.92 | 252.27 |
| | Tetracarboxylic dianhydride to | | 0.98 | 0.98 | 0.98 | 0.98 | 0.98 |
| | diamine compound (molar ratio) | | | | | | |
| | Organic amine | Chemical | MMO | Pyridine | γ-Picoline | 2,4,6-Collidine | Morpholine |
| | compound | species 1 | | | | | |
| | | g | 250.00 | 39.10 | 46.04 | 57.25 | 43.06 |
| | | mmol | 2471.6 | 494.32 | 494.32 | 472.42 | 494.32 |
| | | Chemical | — | — | — | — | — |
| | | species 2 | | | | | |
| | | g | — | — | — | — | — |
| | | mmol | — | — | — | — | — |
| | Treatment rate | % by mole | 500 | 100 | 100 | 100 | 100 |
| | Solvent | Chemical | Water | Water | Water | Water | Water |
| | | species 1 | | | | | |
| | | g | 900 | 900 | 900 | 900 | 900 |
| | | Chemical | — | — | — | — | — |
| | | species 2 | | | | | |
| | | g | — | — | — | — | — |
| | Lactone | Chemical | γ-Valero- | γ-Valero- | γ-Valero- | γ-Valero- | γ-Valero- |
| | | species | lactone | lactone | lactone | lactone | lactone |
| | | g | 10.00 | 10.00 | 10.00 | 10.00 | 10.00 |
| | | mmol | 99.88 | 99.88 | 99.88 | 99.88 | 99.88 |
| | Polyimide precursor | % | 13 | 13 | 13 | 13 | 13 |
| | solid content | | | | | | |
| | Liquid state | | Dissolved | Dissolved | Dissolved | Dissolved | Dissolved |
| | Imidization rate | | 0.02 | 0.05 | 0.05 | 0.06 | 0.02 |
| | Molecular weight | Mn | 20000 | 100000 | 20000 | 20000 | 20000 |
| | Polyimide solid | % | 9.1 | 9.1 | 9.1 | 9.3 | 9.1 |
| | content | | | | | | |
| | Viscosity | Pa · s | 10 | 40 | 40 | 20 | 60 |
| | Terminal amino group | | Contained | Contained | Contained | Contained | Contained |
| Storage | Storage condition | | At room | At room | At room | At room | At room |
| stability | | | temperature | temperature | temperature | temperature | temperature |
| | | | for 20 days | for 20 days | for 20 days | for 20 days | for 20 days |
| | Liquid state | | Dissolved | Dissolved | Dissolved | Dissolved | Dissolved |
| | Viscosity | Pa · s | 50 | 60 | 72 | 40 | 125 |
| | Imidization rate | | 0.04 | 0.03 | 0.05 | 0.02 | 0.06 |
| Coating | Surface unevenness and | | B | A | A | A | C |
| stability | patterns | | | | | | |
| | Cissing | | B | A | B | A | B |
| Film | Void marks | | B | A | B | B | B |
| forming | Surface unevenness and | | B | A | C | B | C |
| properties | patterns | | | | | | |
| | Whitening | | B | A | A | A | B |
| Dynamic | Tensile strength | MPa | 340 | 300 | 320 | 190 | 295 |
| character- | Tensile elongation | % | 50 | 50 | 45 | 70 | 40 |
| istics | | | | | | | |

TABLE 3

| | | | Example/Comparative Example | | | | |
|---|---|---|---|---|---|---|---|
| | | | Example 11 | Example 12 | Example 13 | Example 14 | Example 15 |
| Polyimide precursor composition | | | A-11 | A-12 | A-13 | A-14 | A-15 |
| Synthesis | Tetracarboxylic | Chemical | BPDA | BPDA | CBDA | BPDA | BPDA |
| condition | dianhydride | species | | | | | |
| | | g | 72.72 | 72.72 | 67.46 | 72.72 | 72.72 |
| | | mmol | 247.16 | 247.16 | 290.60 | 247.16 | 247.16 |
| | Diamine | Chemical | PDA | PDA | 1,6-Cyclo- | PDA | PDA |
| | compound | species | | | hexanediamine | | |
| | | g | 27.28 | 27.28 | 32.54 | 27.28 | 27.28 |
| | | mmol | 252.27 | 252.27 | 284.96 | 252.27 | 252.27 |
| | Tetracarboxylic dianhydride to | | 0.98 | 0.98 | 1.02 | 0.98 | 0.98 |
| | diamine compound (molar ratio) | | | | | | |
| | Organic amine | Chemical | Ethyl- | 2-Ethyl-4- | MMO | DMAEt | MMO |
| | compound | species 1 | morpholine | methylimidazole | | | |
| | | g | 54.45 | 56.93 | 58.79 | 25.00 | 50.00 |
| | | mmol | 494.32 | 494.32 | 581.20 | 247.16 | 494.32 |
| | | Chemical | — | — | — | Pyridine | — |
| | | species 2 | | | | | |
| | | g | — | — | — | 19.55 | — |
| | | mmol | — | — | — | 247.16 | — |
| | Treatment rate | % by mole | 100 | 100 | 100 | 100 | 100 |
| | Solvent | Chemical | Water | Water | Water | Water | Water |
| | | species 1 | | | | | |
| | | g | 900 | 900 | 900 | 900 | 900 |
| | | Chemical | — | — | — | — | — |
| | | species 2 | | | | | |
| | | g | — | — | — | — | — |
| | Lactone | Chemical | γ-Valero- | γ-Valero- | γ-Valero- | δ-Valero- | ε-Capro- |
| | | species | lactone | lactone | lactone | lactone | lactone |
| | | g | 10.00 | 10.00 | 10.00 | 10.00 | 10.00 |
| | | mmol | 99.88 | 99.88 | 99.88 | 99.88 | 87.61 |
| | Polyimide precursor | % | 13 | 13 | 13 | 13 | 13 |
| | solid content | | | | | | |
| | Liquid state | | Dissolved | Dissolved | Dissolved | Dissolved | Dissolved |
| | Imidization rate | | 0.02 | 0.02 | 0.02 | 0.02 | 0.02 |
| | Molecular weight | Mn | 20000 | 20000 | 20000 | 100000 | 100000 |
| | Polyimide solid | % | 9.1 | 9.1 | 9.1 | 9.1 | 9.1 |
| | content | | | | | | |
| | Viscosity | Pa · s | 60 | 60 | 30 | 40 | 40 |
| | Terminal amino group | | Contained | Contained | Not detected | Contained | Contained |
| Storage | Storage condition | | at room | at room | at room | at room | at room |
| stability | | | temperature | temperature | temperature | temperature | temperature |
| | | | for 20 days | for 20 days | for 20 days | for 20 days | for 20 days |
| | Liquid state | | Dissolved | Dissolved | Dissolved | Dissolved | Dissolved |
| | Viscosity | Pa · s | 62 | 62 | 45 | 60 | 61 |
| | Imidization rate | | 0.02 | 0.02 | 0.04 | 0.05 | 0.05 |
| Coating | Surface unevenness and | | A | A | B | B | B |
| stability | patterns | | | | | | |
| | Cissing | | A | A | B | B | B |
| Film | Void marks | | A | A | B | B | B |
| forming | Surface unevenness and | | A | A | B | B | B |
| properties | patterns | | | | | | |
| | Whitening | | A | A | B | B | B |
| Dynamic | Tensile strength | MPa | 190 | 190 | 190 | 190 | 190 |
| character- | Tensile elongation | % | 80 | 80 | 80 | 80 | 80 |
| istics | | | | | | | |

TABLE 4

| | | | Example/Comparative Example | | | | |
|---|---|---|---|---|---|---|---|
| | | | Example 16 | Example 17 | Example 18 | Example 19 | Example 20 |
| Polyimide precursor composition | | | A-16 | A-17 | A-18 | A-19 | A-20 |
| Synthesis | Tetracarboxylic | Chemical | BPDA | BPDA | BPDA | BPDA | BPDA |
| condition | dianhydride | species | | | | | |
| | | g | 72.72 | 72.72 | 72.72 | 72.72 | 72.72 |
| | | mmol | 247.16 | 247.16 | 247.16 | 247.16 | 247.16 |
| | Diamine | Chemical | PDA | PDA | PDA | PDA | PDA |
| | compound | species | | | | | |
| | | g | 27.28 | 27.28 | 27.28 | 27.28 | 27.28 |
| | | mmol | 252.27 | 252.27 | 252.27 | 252.27 | 252.27 |
| | Tetracarboxylic dianhydride to | | 0.98 | 0.98 | 0.98 | 0.98 | 0.98 |
| | diamine compound (molar ratio) | | | | | | |
| | Organic amine | Chemical | MMO | MMO | MMO | MMO | MMO |
| | compound | species 1 | | | | | |
| | | g | 50.00 | 50.00 | 50.00 | 50.00 | 50.00 |
| | | mmol | 494.32 | 494.32 | 494.32 | 494.32 | 494.32 |
| | | Chemical | — | — | — | — | — |
| | | species 2 | | | | | |
| | | g | — | — | — | — | — |
| | | mmol | — | — | — | — | — |
| | Treatment rate | % by mole | 100 | 100 | 100 | 100 | 100 |
| | Solvent | Chemical | Water | Water | Water | Water | Water |
| | | species 1 | | | | | |
| | | g | 900 | 400 | 900 | 900 | 900 |
| | | Chemical | — | — | NMP | DMI | 3-Methoxy-N,N- |
| | | species 2 | | | | | dimethyl- |
| | | | | | | | propanamide |
| | | g | — | — | — | — | — |
| | Lactone | Chemical | γ-Valero- | γ-Valero- | γ-Valero- | γ-Valero- | γ-Valero- |
| | | species | lactone | lactone | lactone | lactone | lactone |
| | | g | 0.01 | 500 | 10.00 | 10.00 | 10.00 |
| | | mmol | 0.10 | 4994.01 | 99.88 | 99.88 | 99.88 |
| | Polyimide precursor | % | 13 | 13 | 13 | 13 | 13 |
| | solid content | | | | | | |
| | Liquid state | | Dissolved | Dissolved | Dissolved | Dissolved | Dissolved |
| | Imidization rate | | 0.02 | 0.02 | 0.02 | 0.02 | 0.02 |
| | Molecular weight | Mn | 20000 | 20000 | 20000 | 20000 | 20000 |
| | Polyimide solid | % | 9.1 | 9.1 | 9.1 | 9.1 | 9.1 |
| | content | | | | | | |
| | Viscosity | Pa · s | 60 | 60 | 60 | 60 | 60 |
| | Terminal amino group | | Contained | Contained | Contained | Contained | Contained |
| Storage | Storage condition | | at room | at room | at room | at room | at room |
| stability | | | temperature | temperature | temperature | temperature | temperature |
| | | | for 20 days | for 20 days | for 20 days | for 20 days | for 20 days |
| | Liquid state | | Dissolved | Dissolved | Dissolved | Dissolved | Dissolved |
| | Viscosity | Pa · s | 62 | 62 | 62 | 62 | 62 |
| | Imidization rate | | 0.03 | 0.03 | 0.03 | 0.03 | 0.03 |
| Coating | Surface unevenness and | | B | B | B | B | B |
| stability | patterns | | | | | | |
| | Cissing | | B | B | B | B | B |
| Film | Void marks | | B | B | B | B | B |
| forming | Surface unevenness and | | B | B | B | B | B |
| properties | patterns | | | | | | |
| | Whitening | | B | B | B | B | B |
| Dynamic | Tensile strength | MPa | 320 | 320 | 290 | 300 | 320 |
| character- | Tensile elongation | % | 50 | 70 | 50 | 50 | 60 |
| istics | | | | | | | |

TABLE 5

| | | | Example/Compar- | |
|---|---|---|---|---|
| | | | ative Example | |
| | | | Example 21 | Example 22 |
| Polyimide precursor composition | | | A-21 | A-22 |
| Synthesis | Tetracarboxylic | Chemical | BPDA | BPDA |
| condition | dianhydride | species | | |
| | | g | 72.72 | 72.72 |
| | | mmol | 247.16 | 247.16 |
| | Diamine | Chemical | PDA | PDA |
| | compound | species | | |
| | | g | 27.28 | 27.28 |
| | | mmol | 252.27 | 252.27 |
| | Tetracarboxylic dianhydride to | | 0.98 | 0.98 |
| | diamine compound (molar ratio) | | | |
| | Organic amine | Chemical | MMO | MMO |
| | compound | species 1 | | |
| | | g | 50.00 | 50.00 |
| | | mmol | 494.32 | 494.32 |
| | | Chemical | — | — |
| | | species 2 | | |
| | | g | — | — |
| | | mmol | — | — |
| | Treatment rate | % by mole | 100 | 100 |
| | Solvent | Chemical | Water | Water |
| | | species 1 | | |
| | | g | 900 | 900 |
| | | Chemical | — | — |
| | | species 2 | | |
| | | g | — | — |
| | Lactone | Chemical | γ-Valero- | γ-Valero- |
| | | species | lactone | lactone |
| | | g | 0.005 | 520.00 |
| | | mmol | 0.05 | 5193.77 |
| | Polyimide precursor | % | 13 | 13 |
| | solid content | | | |
| | Liquid state | | Dissolved | Dissolved |
| | Imidization rate | | 0.02 | 0.02 |
| | Molecular weight | Mn | 20000 | 20000 |
| | Polyimide solid | % | 9.1 | 9.1 |
| | content | | | |
| | Viscosity | Pa · s | 60 | 40 |
| | Terminal amino group | | Contained | Contained |
| Storage | Storage condition | | at room | at room |
| stability | | | temperature | temperature |
| | | | for 20 days | for 20 days |
| | Liquid state | | Dissolved | Dissolved |
| | Viscosity | Pa · s | 62 | 65 |
| | Imidization rate | | 0.03 | 0.03 |
| Coating | Surface unevenness and | | B | C |
| stability | patterns | | | |
| | Cissing | | B | C |
| Film | Void marks | | B | B |
| forming | Surface unevenness and | | C | B |
| properties | patterns | | | |
| | Whitening | | C | C |
| Dynamic | Tensile strength | MPa | 270 | 250 |
| character- | Tensile elongation | % | 40 | 50 |
| istics | | | | |

TABLE 6

| | | | Example/Comparative Example | | | | |
|---|---|---|---|---|---|---|---|
| | | | Comparative | | Comparative | Comparative | Comparative |
| | | | Example 1 | | Example 2 | Example 3 | Example 4 |
| Polyimide precursor composition | | | X-1 | X-2 | X-3 | X-4 | X-5 |
| Synthesis | Tetracarboxylic | Chemical | BPDA | | BPDA | PMDA | BTDA |
| condition | dianhydride | species | | | | | |
| | | g | 72.72 | | 72.72 | 51.52 | 74.32 |
| | | mmol | 247.16 | | 247.16 | 236.21 | 223.7 |
| | Diamine | Chemical | PDA | | PDA | ODA | PDA |
| | compound | species | | | | | |
| | | g | 27.28 | | 27.28 | 48.24 | 25.45 |
| | | mmol | 252.27 | | 252.27 | 240.92 | 235.35 |
| | Tetracarboxylic dianhydride to | | 0.98 | | 0.98 | 0.98 | 0.98 |
| | diamine compound (molar ratio) | | | | | | |
| | Organic amine | Chemical | Pyridine | | MMO | Pyridine | — |
| | compound | species 1 | | | | | |
| | | g | 39.10 | | 50.00 | 37.37 | — |
| | | mmol | 494.32 | | 494.32 | 472.42 | — |
| | | Chemical | — | | — | — | — |
| | | species 2 | | | | | |
| | | g | — | | — | — | — |
| | | mmol | — | | — | — | — |
| | Treatment rate | % by mole | | | 100 | 100 | — |
| | Solvent | Chemical | NMP | | Anisole | Water | Water |
| | | species 1 | | | | | |
| | | g | 900 | | 900 | 900 | 900 |
| | | Chemical | — | | — | — | — |
| | | species 2 | | | | | |
| | | g | — | | — | — | — |
| | Lactone | Chemical | γ-Valero- | | γ-Valero- | — | γ-Valero- |
| | | species | lactone | | lactone | | lactone |
| | | g | 10.00 | | 10.00 | — | 10.00 |
| | | mmol | 99.88 | | 99.88 | — | 99.88 |
| | Polyimide precursor | % | 13 | | 13 | 13 | 13 |
| | solid content | | | | | | |
| | Liquid state | | Dissolved | | Dissolved | Dissolved | Dissolved |
| | Imidization rate | | 0.02 | | 0.02 | 0.02 | 0.02 |
| | Molecular weight | Mn | 20000 | | 20000 | 20000 | 20000 |
| | Polyimide solid | % | 9.1 | | 9.1 | 9.3 | 9.2 |
| | content | | | | | | |
| | Viscosity | Pa · s | 120 | | 60 | 50 | 60 |
| | Terminal amino group | | Contained | | Contained | Contained | Contained |
| Storage | Storage condition | | Immediately | at room | at room | at room | at room |
| stability | | | after | temperature | temperature | temperature | temperature |
| | | | preparation | for 20 days | for 20 days | for 20 days | for 20 days |
| | Liquid state | | Dissolved | Precipitated | Thickened | Dissolved | Gelled |
| | Viscosity | Pa · s | 120 | — | — | 140 | — |
| | Imidization rate | | 0.3 | — | — | 0.35 | — |
| Coating | Surface unevenness and | | D | — | — | C | — |
| stability | patterns | | | | | | |
| | Cissing | | C | — | — | C | — |
| Film | Void marks | | C | — | — | D | — |
| forming | Surface unevenness and | | D | — | — | D | — |
| properties | patterns | | | | | | |
| | Whitening | | D | — | — | D | — |
| Dynamic | Tensile strength | MPa | 150 | — | — | 180 | — |
| character- | Tensile elongation | % | 10 | — | — | 20 | — |
| istics | | | | | | | |

From the above results, it can be seen that the evaluation results of the storage stability of the polyimide precursor composition obtained in the present Examples are better than those obtained in Comparative Examples.

Incidentally, it can be seen that the evaluation results of the coating stability and the film forming properties of the polyimide precursor composition obtained in the present Examples are also superior to those obtained in Comparative Examples. In addition, it can be seen that the evaluation results of the mechanical strength with respect to the present Examples are also good.

Moreover, the abbreviations and the like in Tables 1 to 5 are as follows. In addition, “-” in Tables 1 to 5 indicates that the component is not added or the process is not conducted.
Tetracarboxylic dianhydride: “BPDA” (3,3′,4,4′-biphenyltetracarboxylic dianhydride), “PMDA” (pyromellitic dianhydride), “BTDA” (benzophenonetetracarboxylic dianhydride), and “CBDA” (cyclobutane-1,2:3,4-tetracarboxylic dianhydride)
Diamine compound: “ODA” (4,4′-diaminodiphenyl ether) and “PDA” (p-phenylenediamine)
Organic amine compound: MMO (methylmorpholine: a tertiary amine compound having a nitrogen-containing heterocyclic structure: a boiling point of 115° C. to 116° C.) pyridine (a tertiary amine compound having a nitrogen-containing heterocyclic structure: a boiling point of 115° C. to 116° C.), γ-picoline (a tertiary amine compound: a boiling point of 145° C.), 2,4,6-collidine (a compound having a nitrogen-containing heterocyclic structure: a molecular weight of 121.18 and a boiling point of 171° C.), morpholine (a secondary amine compound having a nitrogen-containing heterocyclic structure: a molecular weight of 87.1 and a boiling point of 129° C.), ethylmorpholine (a tertiary amine compound having a nitrogen-containing heterocyclic structure: a molecular weight of 115.17 and a boiling point of 139° C.), 2-ethyl-4-methylimidazole (a tertiary amine compound having a nitrogen-containing heterocyclic structure: a molecular weight of 110.16 and a boiling point of 292° C. to 295° C.), and DMAEt (dimethylaminoethanol: a tertiary amine compound: boiling point of 133° C. to 134° C.)
Solvent: THF (tetrahydrofuran: a water-soluble ether solvent: a boiling point of 67° C.), NMP (N-methyl-2-pyrrolidone), DMI (1,3-dimethyl-2-imidazolidinone, a boiling point of 224° C. to 226° C.), and 3-methoxy-N,N-dimethylpropanamide (a boiling point of 215° C.)

Furthermore, in the present Examples, the “treatment rate” in the polymerization step is the amount (% by mole) of organic amine compounds with respect to the theoretical amount of carboxyl groups contained in the polyimide precursor. Here, the theoretical amount of carboxyl groups represents a value obtained by doubling the molar amount of tetracarboxylic dianhydride contained in the polyimide precursor.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A polyimide precursor composition, comprising a solution including therein a resin having repeating units represented by the following formula (I), a lactone compound, an organic amine compound, and a solvent including water, wherein the water content is 10% to 100% by weight of the entire solvent,
wherein the resin, the lactone compound and the organic amine compound are dissolved in the solvent: 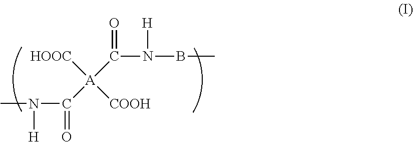
wherein A represents a tetravalent organic group and B represents a divalent organic group.

2. The polyimide precursor composition according to claim 1, wherein the lactone compound is at least one selected from the group consisting of γ-valerolactone, δ-valerolactone, and ε-caprolactone.

3. The polyimide precursor composition according to claim 1, wherein the organic amine compound is a tertiary amine compound.

4. The polyimide precursor composition according to claim 2, wherein the organic amine compound is a tertiary amine compound.

5. The polyimide precursor composition according to claim 1, wherein the organic amine compound is an amine compound having a nitrogen-containing heterocyclic structure.

6. The polyimide precursor composition according to claim 2, wherein the organic amine compound is an amine compound having a nitrogen-containing heterocyclic structure.

7. The polyimide precursor composition according to claim 1, wherein the organic amine compound is at least one selected from the group consisting of morpholines, pyridines, and imidazoles.

8. The polyimide precursor composition according to claim 2, wherein the organic amine compound is at least one selected from the group consisting of morpholines, pyridines, and imidazoles.

9. The polyimide precursor composition according to claim 1, wherein the organic amine compound is at least one selected from the group consisting of N-methylmorpholine, pyridine, and picoline.

10. The polyimide precursor composition according to claim 2, wherein the organic amine compound is at least one selected from the group consisting of N-methylmorpholine, pyridine, and picoline.

11. The polyimide precursor composition according to claim 1, wherein a content of the lactone compound is from 0.01% by weight to 500% by weight with respect to the weight of the resin.

12. The polyimide precursor composition according to claim 1, wherein a content of the lactone compound is from 0.01% by mole to 100% by mole with respect to the organic amine compound.

13. The polyimide precursor composition according to claim 1, wherein the resin is a synthetic resin formed of a tetracarboxylic dianhydride and a diamine compound, and the molar equivalents of the diamine compound are larger than the molar equivalents of the tetracarboxylic dianhydride.

14. The polyimide precursor composition according to claim 1, wherein the resin is a resin having a terminal amino group.

15. The polyimide precursor composition according to claim 1, wherein the resin is a synthetic resin formed of an aromatic tetracarboxylic dianhydride and an aromatic diamine compound.

16. The polyimide precursor composition according to claim 1, wherein the resin has an imidization rate of 0.2 or less.

17. The polyimide precursor composition according to claim 1, wherein the resin has repeating units represented by the formulae (I-1), (I-2), and (I-3): 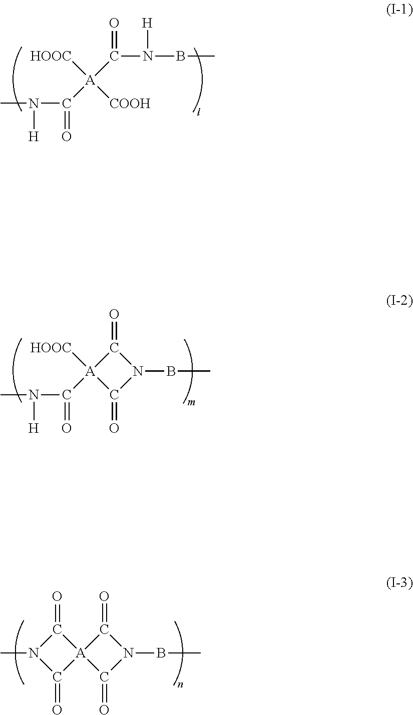
wherein A represents a tetravalent organic group, B represents a divalent organic group, 1 represents an integer of 1 or more, and m and n each independently represent 0 or an integer of 1 or more, with l, m, and n satisfying a relationship of (2n+m)/(2l+2m+2n)≦0.2.

18. A polyimide molded article molded by heating the polyimide precursor composition according to claim 1.

19. A method for preparing a polyimide molded article comprising molding the polyimide precursor composition according to claim 1 by heating.

20. The polyimide precursor composition according to claim 1, wherein the water content is 50% to 100% by weight of the entire solvent.

21. The polyimide precursor composition according to claim 1, wherein the water content is 90% to 100% by weight of the entire solvent.
